(19) United States
(12) Patent Application Publication
(10) Pub. No.: US 2006/0271387 A1
(43) Pub. Date: Nov. 30, 2006

(54) System for providing a user with shipping information

(75) Inventors: Frank Anthony Gruger, South Holland, IL (US); Leigh Seth Goldstein, San Francisco, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: eBay Inc.

(21) Appl. No.: 11/171,794

(22) Filed: Jun. 30, 2005

Related U.S. Application Data
(60) Provisional application No. 60/685,715, filed on May 27, 2005.

(51) Int. Cl. G06Q 99/00

(52) U.S. Cl. 705/1

(57) ABSTRACT

A method of providing a user with shipping information includes receiving a request from a user for shipping information regarding the shipping of an item, the request including an item identification which identifies the item. A database is accessed containing historical shipping information of items whose shipping information has previously been captured. The item identification is used to identify at least one comparable item whose historical shipping information is stored in the database. This historical shipping information is extracted and outputted to the user.

### RELATED APPLICATION

This application claims priority under 35 U.S.C. 119(e) from U.S. Provisional Application Ser. No. 60/685,715 filed 27 May 2005, which application is incorporated herein by reference.

### TECHNICAL FIELD

The present application relates generally to the field of data and information processing, and more particularly to systems and methods for providing a user with shipping information.

### BACKGROUND

The shipping of items from one geographic location to another is an everyday occurrence. The shipping may take place via the air, land or sea and may occur for any one of a number of underlying reasons which result in the need for the item to be shipped from one geographic location to another.

The item may take various forms and may be something relatively small such as a music disc, book or cellular phone, for example or may be something relatively larger such as a motor vehicle, for example.

In any event, a user may need to obtain shipping information about a particular item that will be shipped.

Therefore, what is needed is a system that is able to provide a user with shipping information.

### SUMMARY

According to one embodiment, there is provided a method of providing a user with shipping information, the method including:
receiving a request from a user for shipping information regarding the shipping of an item, the request including an item identification which identifies the item;
accessing a database containing historical shipping information of items whose shipping information has previously been captured;
identifying, using the item identification, at least one comparable item whose historical shipping information is stored in the database;
extracting the historical shipping information of the at least one comparable item from the database; and
outputting the historical shipping information to the user.

According to another embodiment, there is provided a system for providing a user with shipping information, the system including:
an interface to receive a request from a user for shipping information regarding the shipping of an item, the request including an item identification which identifies the item;
a database to contain historical shipping information of items whose shipping information has previously been captured; and
at least one processor for executing a shipping information application for identifying, using the item identification, at least one comparable item whose historical shipping information is stored in the database, extracting the historical shipping information of the at least one comparable item from the database and for outputting the historical shipping information to the user.

### BRIEF DESCRIPTION OF THE DRAWINGS

Example embodiments of the present invention are illustrated by way of example and not limitation in the figures of the accompanying drawings, in which like references indicate similar elements and in which:

FIG. 1 is a network diagram depicting a system, according to one example embodiment of the present invention;

FIG. 2 is a block diagram illustrating multiple marketplace and payment applications;

FIG. 3 is a high-level entity-relationship diagram;

FIG. 4 is a flow diagram showing the operations in one embodiment of the present invention;

FIG. 5 shows a diagrammatic representation of a machine for performing any one or more of the operations of the present invention; and

FIGS. 6-9 show example user interfaces that may be generated by a commerce system.

### DETAILED DESCRIPTION

In the following Detailed Description, reference is made to the accompanying Drawings which form a part hereof, and in which are shown by way of illustration specific embodiments in which the invention may be practiced. It is to be understood that other embodiments may be utilized and structural changes may be made without departing from the scope of the present invention.

An example embodiment will be described with reference to the shipping of an item from a seller to a purchaser, wherein the item has been or will be offered for sale over a network (e.g., the Internet). It will be appreciated that this is an example application for the invention which could also be implemented in other scenarios where shipping of an item is required.

Platform Architecture

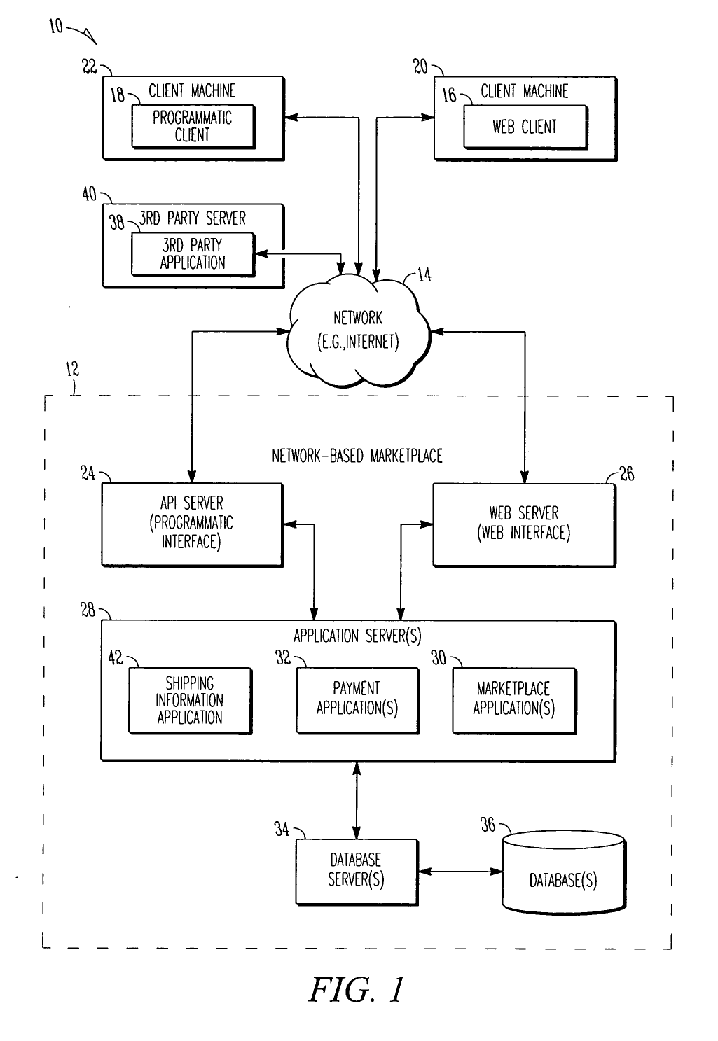

FIG. 1 is a network diagram depicting a system 10, according to one example embodiment of the present invention, having a client-server architecture. A commerce system, in the example form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32.The application servers 28 are, in turn, shown to be coupled to one or more databases servers 34 that facilitate access to one or more databases 36.

The marketplace applications 30 provide a number of marketplace functions and services to users that access the marketplace 12. The payment applications 32 likewise provide a number of payment services and functions to users. The payment applications 30 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32 are shown in FIG. 1 to both form part of the network-based marketplace 12, it will be appreciated that, in alternative embodiments, the payment applications 32 may form part of a payment service that is separate and distinct from the marketplace 12.

Further, while the system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities.

The web client 16 accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

Also Included in the figure is a shipping information application 42 whose operation will be described in more detail below.

Marketplace Applications

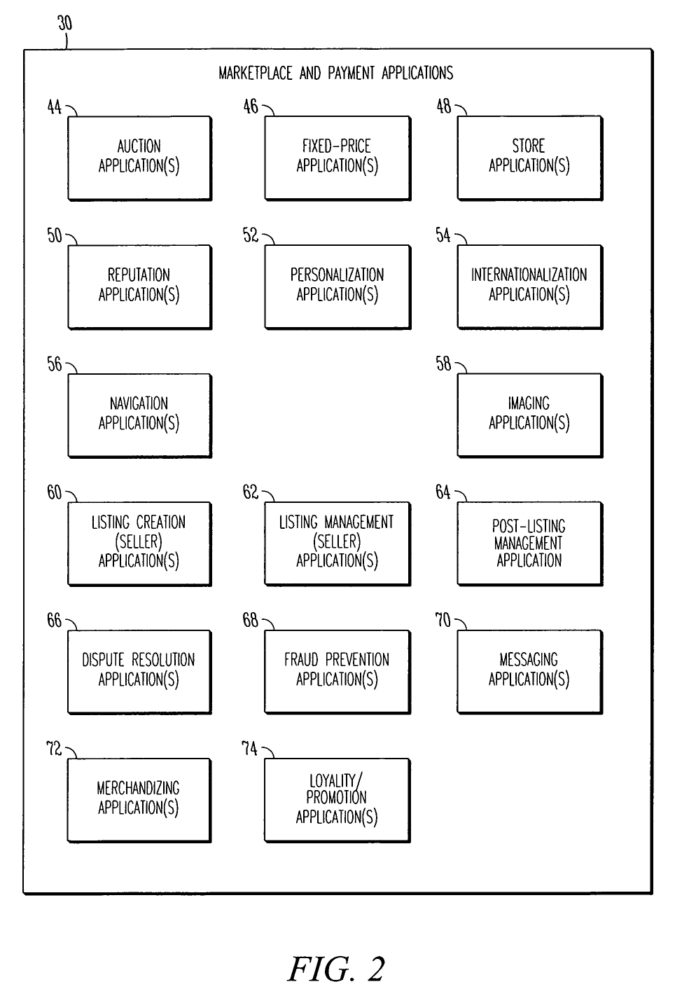

FIG. 2 is a block diagram illustrating multiple marketplace and payment applications 30 that, in one example embodiment of the present invention, are provided as part of the network-based marketplace 12. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 80 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

Data Structures

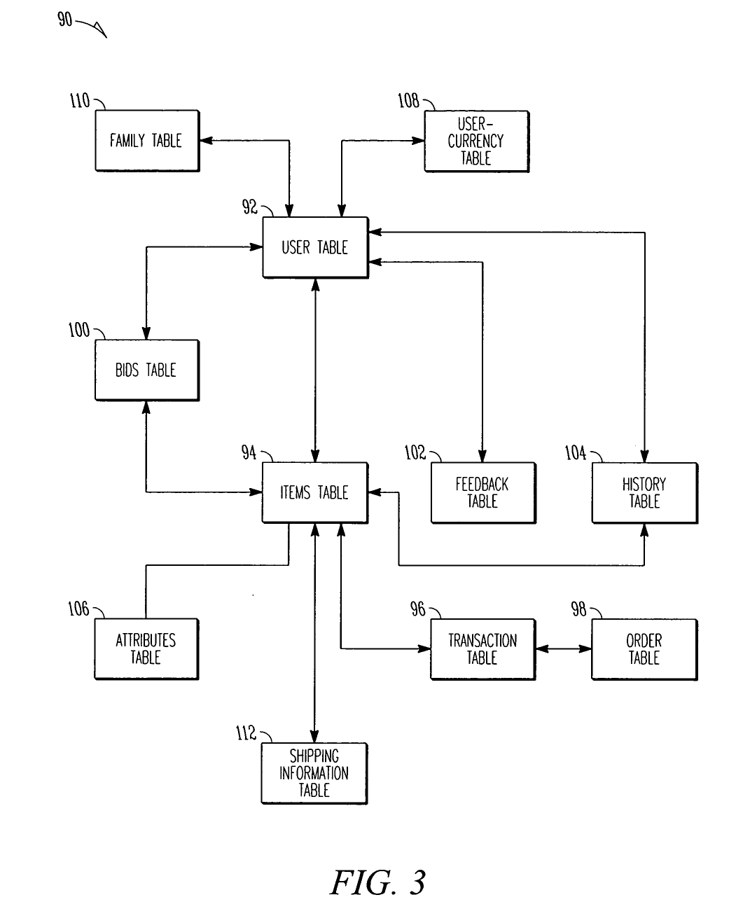

FIG. 3 is a high-level entity-relationship diagram, illustrating various tables 90 that may be maintained within the databases 36, and that are utilized by and support the marketplace and payment applications 30 and 32. A user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In one example embodiment of the present invention, a buyer may be a user that has accumulated value (e.g., commercial or proprietary currency), and is then able to exchange the accumulated value for items that are offered for sale by the network-based marketplace 12.

The tables 90 also include an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

Shipping information records within a shipping information table 112 each relate to historical shipping information of an item. The historical shipping information may be the cost of shipping the item, the shipping weight of the item, the method of shipping of the item or any other shipping information.

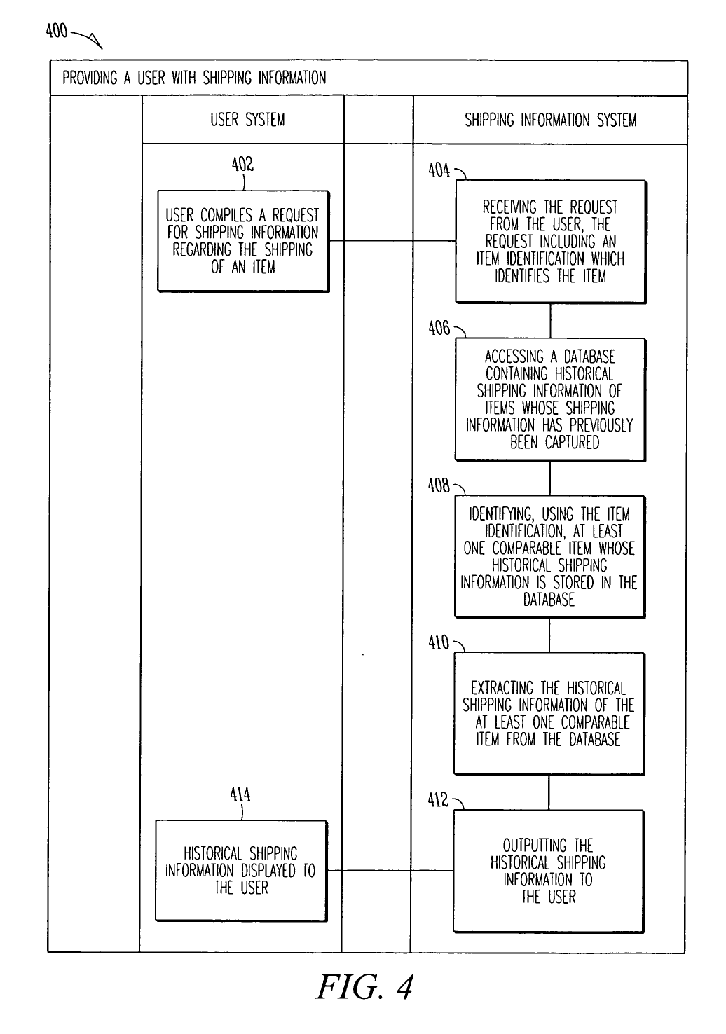

Referring to FIG. 4, a user of the system 10 wishing to obtain shipping information compiles a request for the shipping information regarding the shipping of an item (block 402).

In the example embodiment, the user will compile the request using client machine 20 or 22 and transmit the request over the network 14 to the network based marketplace 12, for example.

The request is routed to the shipping information application 42 being executed, for example, on one or more processors of one or more application servers 28. The shipping information application 42 receives the request from the user (block 404).

The request includes item identification information, which identifies the items for which the user requires the shipping information.

The shipping information application 42 accesses a database 36 containing historical shipping information of items whose shipping information has previously been captured.

This information could have been captured when an item was previously actually shipped, for example.

In any event, the shipping information application 42 identifies, using the item identification information, at least one other comparable item (block 408).

The comparable item is selected as being at least one of an identical item and a similar item.

This can be done in a number of ways. Firstly, the item identification information received from the user may be very specific, such as a Universal Product Code (UPC). In this case, the shipping information application 42 will identify in the database an item with the same UPC code which will be an identical item.

Alternatively, the shipping information application 42 may not be able to find an item with the same UPC code or may be configured not to search by UPC codes but to search for other similar items within a same category, the category being identified by (or identifiable using) the item identification information.

Furthermore, a sophisticated search algorithm could be employed to locate similar items based on keyword searching or attribute searching. An example of an attribute may be color. The keywords and/or attribute information may likewise been included in the item identification information.

Once a comparable item is identified in the database 36, historical shipping information of the item is extracted (block 410).

This historical information is then output to the user (block 412).

Information will typically be displayed to the user (block 414) via the network 14 to the user's client machine 20 or 22.

The type of shipping information requested by a user could be the cost of shipping an item or the shipping weight of an item, for example.

As a number of factors influence the shipping cost, the user may be prompted to enter geographical information. The request from the user may thus include the shipping destination to where the item will be shipped. In this case, the identifying of an item in the database 36 includes identifying at least one comparable item whose destination is stored in the database based on geographical proximity to the requested shipping destination.

In addition, the method of shipping affects the costs. It will be appreciated that an overnight service is more costly then a normal type of service.

As such, the user request may further include, in the request compiled at block 402, the method of shipping which will be used to ship the item. The identifying of an item in the database 36 may In this case also include identifying at least one comparable item whose method of shipping is stored in the database and which is the same as the requested method of shipping.

Where the requested shipping information is, for example, cost or weight, then the information output to the user may be a range of costs or weight or an average cost or weight.

In this embodiment, the historical shipping information for a plurality of comparable items is extracted from the database and the extracted information is used to calculate the range or average. The historical shipping information for each of the plurality of comparable items may also be output to the user.

The average may be a true average of all of the data extracted or the bottom 10 percent and the top 10 percent of the range may be discarded for purposes of calculating the average, for example.

It will be appreciated that the information output to the user may be determined based on actual data for shippings that have already occurred.

In one embodiment, the shipping information may be obtained only from items which have already been shipped while in another embodiment the shipping information may be obtained from any historical shipping information that has been captured but where the item has not necessarily actually been shipped.

One example application for the present invention is where a seller lists a product for sale in an electronic marketplace, such as has been described with reference to FIGS. 1-3.

In this embodiment, in addition to the price of the item being sold or auctioned, the seller can additionally request shipping information be included in, or displayed in conjunction with, other pricing information pertinent to an offer for sale. This would be a flat rate based cost.

Alternatively, the seller can request shipping information in the form of weight, and provide the weight to potential buyers who can then use the weight to calculate their own shipping costs. To this end, a user interface presented to potential buyers, by the marketplace 12, may provide access to a shipping calculator application. Potential buyers can input the weight into the shipping calculator application to determine shipping costs.

In a further embodiment, the shipping information could be a suggested shipping method, based on lowest shipping cost or perhaps even historical service levels provided by various shipping service providers.

While an example application of the invention has been described for use in a commerce system embodiment, a further embodiment could be any application where shipping information needs to be provided to a user. Thus, shipping service providers themselves could use a shipping information application 42 to provide their customers with shipping information, for example.

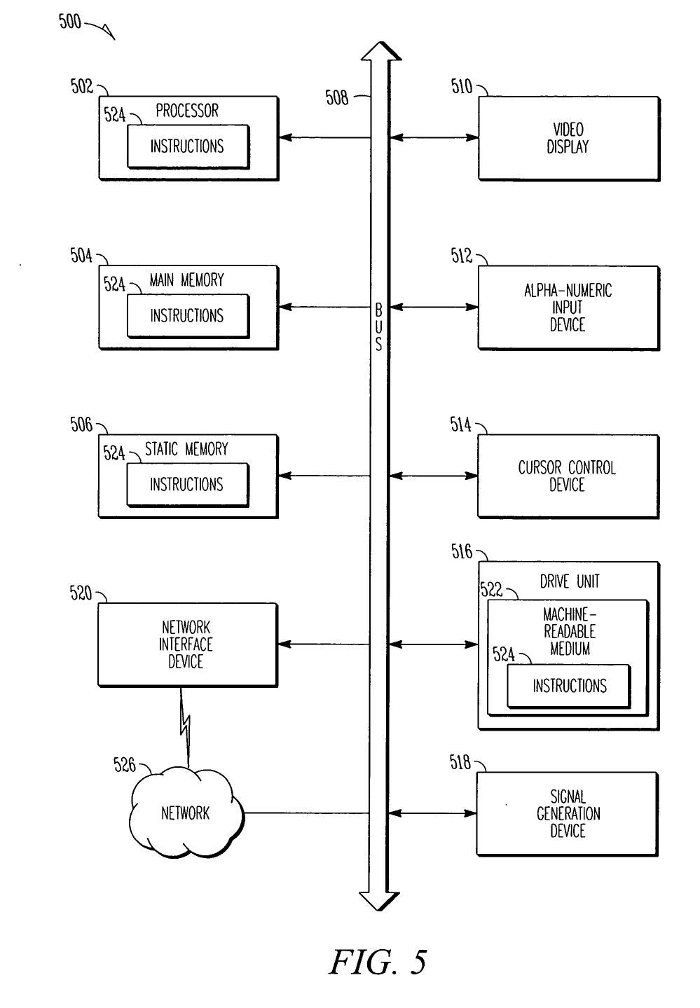

FIG. 5 shows a diagrammatic representation of machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

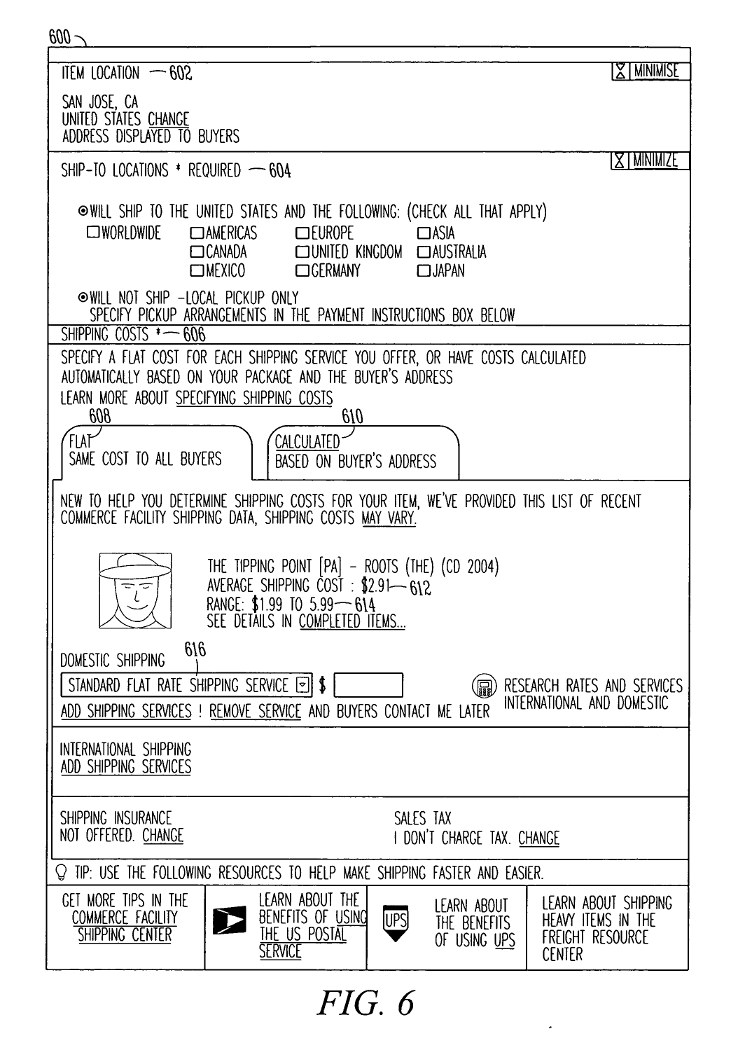

FIG. 6 shows a user interface 600, according to an example embodiment of the present invention, that may be generated by a commerce system (e.g., the above-described shipping application 42 of the marketplace 10) as part of a listing creation (or other information publication) process. As shown, the interface 600 includes an item location section 602, identifying the location from which a seller will be shipping an item, or providing a service. A “shipped to” location section 604 allows the seller to specify geographic regions to which the seller is willing to ship the item, or geographic regions in which the seller is willing to provide a service. A “shipping costs” section 606 enables a seller to specify cost information to be displayed in conjunction with other information regarding an item offered for sale. Two tabs, each corresponding to a manner in which shipping costs may be determined, are shown. Specifically, a “flat” rate shipping cost tab 608 allows the seller to specify a flat rate for shipping of the item, and a “calculated” rate shipping cost tab 610 allows a seller to specify parameters utilizing which shipping costs may be dynamically calculated for a specific buyer location.

Turning specifically to the information displayed in conjunction with the flat rate shipping cost tab 608, an average shipping cost 612 for a particular item is displayed. Further, a range 614 of shipping costs for the relevant item may also be displayed. A drop-down “domestic shipping” option menu 616 also allows a seller to specify a shipping service for which the average and range cost information should be displayed.

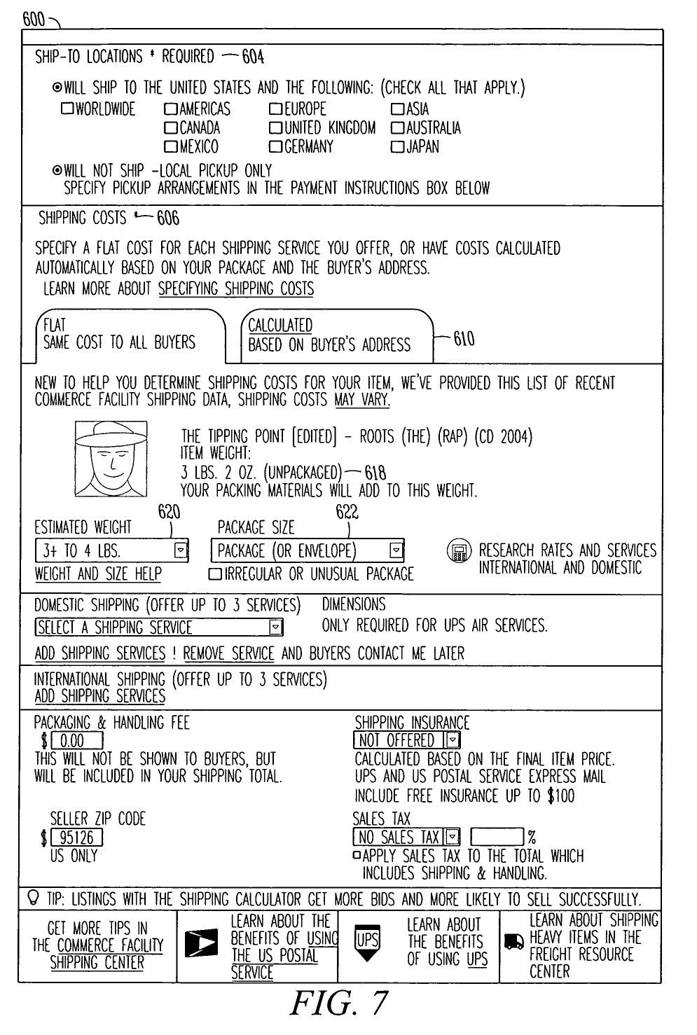

FIG. 7 shows the user interface 600, with the “calculated” rate shipping cost tab 610 active. As shown, this tab 610 displays an item weight 618 for the subject item. In the shown example, the exact weight for the product is known, for example from a product or catalog database. The exact weight may also be known as a result of having been inputted by a user that previously listed the same item, or a substantially similar or comparable item. For example, the weight of a single disk CD package may be assumed to be uniform. However, the weight of a book would tend to be title specific, and also depend on whether the book was a hardcover or soft cover version. To this end, the BIN of a book may be utilized to identify an exact version. Where the item cannot be identified with such specificity, an estimated weight may be displayed.

FIG. 7 also shows the “calculated” rate shipping cost tab 610 as including an estimated weight drop-down menu 620, utilizing which a user may input an estimated weight for the relevant item (e.g., based on the item weight 618 displayed in the tab). Further, the tab 610 includes a package size drop-down menu 622, utilizing which a seller may specify a time, or size, of packaging that would be utilized to ship the product. The estimated weight and package size inputs, received at the system 10 via the interface 60, may be utilized to calculate an estimated shipping cost for the relevant item.

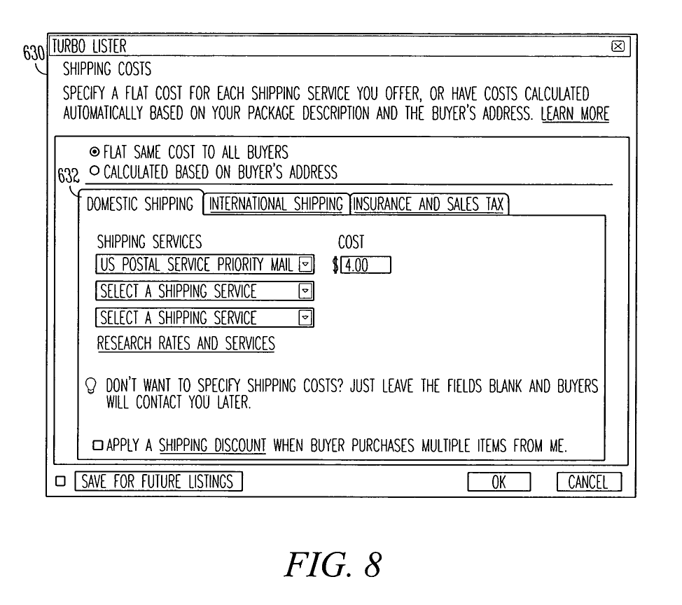

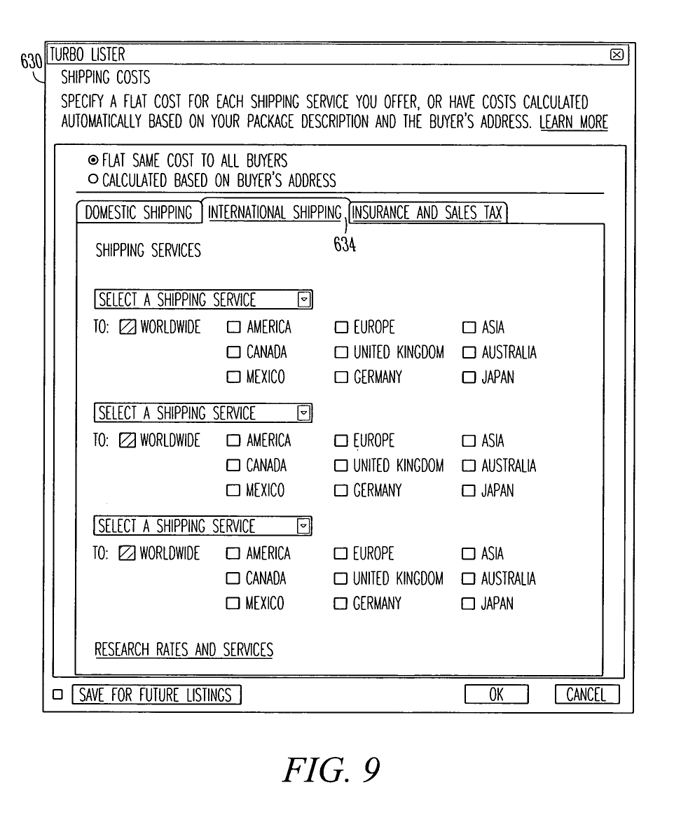

FIGS. 8 and 9 illustrate further shipping cost interface 630 that may be displayed, for example by a programmatic client 18. The shipping cost interface 630 may again allow a user to specify a flat or calculated shipping rate for a particular item listing. Further, the shipping cost interface 630 includes a domestic shipping tab 632, which a user may use to (1) specify which one of a number of shipping services to utilize, and also (2) to associate costs with each of these shipping services. An international shipping tab 634 may further enable a seller to identify one of a number of international destinations to which the seller is willing to ship an item (or deliver a service).

What is claimed is:

1. A system for providing a user with shipping information, the system including:
an interface to receive a request from a user for shipping information regarding the shipping of an item, the request including an item identification which identifies the item;
a database to contain historical shipping information of items whose shipping information has previously been captured; and
at least one processor for executing a shipping information application for identifying, using the item identification, at least one comparable item whose historical shipping information is stored in the database, extracting the historical shipping information of the at least one comparable item from the database and for outputting the historical shipping information to the user.

2. A system according to claim 1 wherein the shipping information application identifies a comparable item which is selected as being at least one of an identical item and a similar item.

3. A system according to claim 1 wherein the shipping information is the cost of shipping the item.

4. A system according to claim 1 wherein the shipping information is the shipping weight of the item.

5. A system according to claim 1, wherein the shipping information application determines that the at least one comparable item has previously shipped, and wherein the historical shipping information is the shipping information of the at least one comparable item that has previously been shipped.

6. A system according to claim 1 wherein the interface is for receiving a request from the user that includes the shipping destination to where the item will be shipped and wherein the shipping information application is further for identifying at least one comparable item whose destination is stored in the database, based on geographical proximity to the requested shipping destination.

7. A system according to claim 1 wherein the interface is for receiving a request from the user that includes the method of shipping which will be used to ship the item and wherein the shipping information application is further for identifying at least one comparable item whose method of shipping is stored in the database and which is the same as the requested method of shipping.

8. A system according to claim 1 wherein the shipping information application is for identifying a plurality of comparable items and extracting the historical shipping information for each of the plurality of comparable items.

9. A system according to claim 8 wherein the shipping information application is further for using the historical shipping information for each of the plurality of comparable items to calculate a range of historical shipping information which range is output to the user.

10. A system according to claim 8 wherein the shipping information application is further for using the historical shipping information for each of the plurality of comparable items to calculate an average historical shipping information which average is output to the user.

11. A system according to claim 8 wherein the shipping information application identifies the plurality of comparable items included in a same category as the item.

12. A system according to claim 8 wherein the shipping information application identifies the plurality of comparable items by conducting a search through the database to identify a plurality of items which have at least one attribute which is similar to the item.

13. A system according to claim 1 wherein the shipping information is the method of shipping of the item.

14. A computer-implemented of providing a user with shipping information, the computer-implemented including:
receiving a request from a user for shipping information regarding the shipping of an item, the request including an item identification which identifies the item;
accessing a database containing historical shipping information of items whose shipping information has previously been captured;
identifying, using the item identification, at least one comparable item whose historical shipping information is stored in the database;
extracting the historical shipping information of the at least one comparable item from the database; and
outputting the historical shipping information to the user.

15. A computer-implemented according to claim 14 wherein the comparable item is selected as being at least one of an identical item and a similar item.

16. A computer-implemented according to claim 14 wherein the shipping information is the cost of shipping the item.

17. A computer-implemented according to claim 14 wherein the shipping information is the shipping weight of the item.

18. A computer-implemented according to claim 14, wherein the identifying of the at least one comparable item includes determining that the at least one comparable item has previously shipped, and wherein the historical shipping information is the shipping information of the at least one comparable item that has previously been shipped.

19. A computer-implemented according to claim 14 wherein the request received from the user includes the shipping destination to where the item will be shipped and wherein the identifying includes identifying at least one comparable item whose destination is stored in the database, based on geographical proximity to the requested shipping destination.

20. A computer-implemented according to claim 14 wherein the request received from the user includes the method of shipping which will be used to ship the item and wherein the identifying includes identifying at least one comparable item whose method of shipping is stored in the database and which is the same as the requested method of shipping.

21. A computer-implemented according to claim 14 wherein a plurality of comparable items is identified and wherein the historical shipping information for each of the plurality of comparable items is extracted.

22. A computer-implemented according to claim 21 wherein the historical shipping information for each of the plurality of comparable items are output to the user.

23. A computer-implemented according to claim 21 wherein the historical shipping information for each of the plurality of comparable items is used to calculate a range of historical shipping information which range is output to the user.

24. A computer-implemented according to claim 21 wherein the historical shipping information for each of the plurality of comparable items is used to calculate an average historical shipping information which average is output to the user.

25. A computer-implemented according to claim 21 wherein the identifying of the plurality of comparable items includes the identifying of a plurality of comparable items included in a same category as the item.

26. A computer-implemented according to claim 21 wherein the identifying of the plurality of comparable items includes conducting a search through the database to identify a plurality of items which have at least one attribute which is similar to the item.

27. A computer-implemented according to claim 14 wherein the shipping information is the computer-implemented of shipping of the item.

28. A machine-readable medium comprising instructions, which when executed by a machine, cause the machine to provide a user with shipping information, the method including:
receiving a request from a user for shipping information regarding the shipping of an item, the request including an item identification which identifies the item;
accessing a database containing historical shipping information of items whose shipping information has previously been captured;
identifying, using the item identification, at least one comparable item whose historical shipping information is stored in the database;
extracting the historical shipping information of the at least one comparable item from the database; and
outputting the historical shipping information to the user.

29. A system for providing a user with shipping information, the system including:
first means for receiving receive a request from a user for shipping information regarding the shipping of an item, the request including an item identification which identifies the item;
second means for containing historical shipping information of items whose shipping information has previously been captured; and
third means for identifying, using the item identification, at least one comparable item whose historical shipping information is stored in the database, extracting the historical shipping information of the at least one comparable item from the database and for outputting the historical shipping information to the user.
